(19) United States
(12) Patent Application Publication
(10) Pub. No.: US 2011/0199194 A1
(43) Pub. Date: Aug. 18, 2011

(54) PROGRAMMABLE DEVICE AND PROGRAMMING METHOD

(75) Inventors: Ian Waldock, Hampshire (GB); Alister Lam, Hampshire (GB); David Tarrant, Hampshire (GB)

(73) Assignee: NXP B.V., Eindhoven (NL)

(21) Appl. No.: 13/058,554

(22) PCT Filed: Aug. 4, 2009
(86) PCT No.: PCT/IB09/53378

§ 371 Date: May 3, 2011

(30) Foreign Application Priority Data
Aug. 11, 2008 (EP) 08105013.0

(51) Int. Cl. H04Q 5/22

(52) U.S. Cl. 340/10.51

(57) ABSTRACT

The present invention discloses a programmable device (10) comprising a controller (14) for processing a sequence of program instructions to control the programmable device; and a near field communication device (12) for retrieving the program instructions from at least one transmission tag (24) and for providing the controller (14) with the retrieved sequence of program instructions. In an embodiment, the controller (14) is arranged to receive individual instructions from respective transmission tags (24). This facilitates the programming of the device (10) by means of instruction-carrying transmission tags, which, amongst others, allows for easy programming of programmable toys such as robots.

### FIELD OF THE INVENTION

The present invention relates to a programmable device comprising a controller for processing a sequence of program instructions to control the programmable device.

The present invention further relates to a method of programming such a programmable device.

### BACKGROUND OF THE INVENTION

Programmable devices can be found in many application domains with a wide variety in the effort and skill required to program such devices. For instance, a personal computer (PC) is an example of a programmable device that is difficult to program by an end user, who typically purchases a ready-to-install software program from a professional software developer.

Examples of programmable devices that are intended to be programmed by the end user, e.g. for educational purposes, can for instance be found in the games market. For example, there are several children's toys on the market that require programming before they can be used. An example of such a toy can be found on the Internet; http://el.media.mit.edu/Logo-foundation/logo/turtle.html discloses a programmable robotic turtle, which has a controller that is configured to receive program instructions through an interface connected to a computer. A child may instruct the robotic turtle to perform certain actions by typing appropriate commands on the keyboard of the computer. However, this has the disadvantage that the child playing with the toy must have access to a computer, which may be difficult to operate for the child, and furthermore introduces the risk that the child may be exposed to content, e.g. on the Internet, which may be considered inappropriate or harmful.

Another example of such a robotic toy can also be found on the Internet: http://www.swallow.co.uk/pixie/pixie1.htm, which discloses an educational robotic toy having a controller responsive to an instruction keyboard integrated in the robotic toy. The presence of the keyboard is aesthetically unsatisfactory, and reduces the marketability of the robotic toy.

### SUMMARY OF THE INVENTION

The present invention seeks to provide a programmable device such as a robotic toy that overcomes at least some of the aforementioned disadvantages.

The present invention further seeks to provide a method for programming a programmable device such as a robotic toy such that at least some of the aforementioned disadvantages can be avoided.

According to a first aspect of the present invention, there is provided a programmable device comprising a controller for processing a sequence of program instructions to control the programmable device; and a near field communication device for retrieving the program instructions from at least one transmission tag and for providing the controller with the retrieved sequence of program instructions. Such a programmable device may be programmed without the need for key-based interfaces such as a computer or an integrated keyboard, and has the further advantage that the device may be produced having a more pleasing appearance due the fact that the device no longer requires a visible programming interface. This is particularly relevant in the toy market where product appearance is a key factor in the sales success of the product.

The use of transmission tags, which are sometimes also referred to as near-field communication (NFC) tags, to program the programmable device furthermore provides educational benefits. In an embodiment, the controller is arranged to receive an individual instruction from a first transmission tag. In other words, the individual instructions in the sequence of program instructions may be fed to the programmable device by means of separate transmission tags each comprising a single instruction. This has the advantage the programmable device may be programmed in many different ways, e.g. by variation of the instruction sequences. The use of the transmission tags, which may be embedded in a suitable carrier such as a laminated card carrying an image, e.g. a pictogram, of the programmable device action triggered by the instruction, enables the user, e.g. a child, to build an instruction sequence by laying out the transmission tags in the desired sequence, which provides a powerful visual representation of the instruction sequence, which cannot be achieved with the prior art programmable devices. Moreover, the ability to program the programmable device in a visual and intuitive manner makes the programming task easier to understand and accessible to a new groups of consumers, e.g. children in lower age brackets in case of a programmable toy.

In an embodiment, the controller is further arranged to receive a parameter for the individual instruction from a second transmission tag. This provides even more programming flexibility, because an instruction requiring a parameter such as execution duration, required number of executions and so on, may be specified by the programmer using the appropriate parameter transmission tag.

The controller may be arranged to enter a programming mode in response to a program initiation transmission tag and to exit the programming mode in response to a program termination transmission tag. This makes it very simple to enter and exit the programming mode of the programming device.

In an embodiment, the programmable device of the present invention is capable of writing a programmed instruction sequence to a transmission tag such that the programmer can reuse a successfully entered instruction sequence. To this end, the programmable device may further comprise a further near field communication device arranged to write the sequence of program instructions to a further transmission tag in response to a sequence write instruction.

Alternatively, the near field communication device for retrieving the program instructions from at least one transmission tag and for providing the controller with the retrieved sequence of program instructions may be further arranged to write the sequence of program instructions to a further transmission tag in response to a sequence write instruction.

The sequence write instruction may be activated by a switch or button on the programmable device. Preferably, the near field communication device for retrieving the program instructions from at least one transmission tag is arranged to receive the sequence write instruction from a transmission tag, such that the appearance of the programmable device is not affected by the presence of such a switch or button.

The programmable device may receive the complete sequence of instructions before executing the instructions in the sequence, in which case the program may be started using a dedicated transmission tag comprising a program start instruction. However, in an alternative embodiment, the controller is arranged to execute the individual instruction before receiving a next instruction. This is for instance advantageous when the programmable device is a robotic toy, because the toy may be instructed to move to a next location where a next transmission tag may be found such that the toy receives its next instruction when completing the previous instruction. This allows the toy to be programmed during play, which reduces the risk that the child will lose interest because of an involved programming process.

The programmable device may further comprise an alarm for notifying an error in the sequence of program instructions. Such an alarm, which may be an audible or visual alarm, e.g. a sound or a flashing light, helps reducing the risk of an error being introduced in a sequence of program instructions.

A set of transmission tags for programming the programmable device of the present invention, wherein at least some of the transmission tags in said set comprising at least one program instruction for said programmable device may be provided separately, such that the owner of the programmable device of the present invention can purchase additional programming instructions during the lifetime of the programmable device.

The programmable device of the present invention may be provided together with the set of transmission tags of the present invention as a programmable system.

According to a further aspect of the present invention, there is provided a method of programming a programmable device comprising a controller for processing a sequence of program instructions to control the programmable device and a near field communication device coupled to the controller, the method comprising establishing a communication between the near field communication device and a first transmission tag comprising at least a part of the sequence of program instructions; retrieving the at least part of the sequence of program instructions from the first transmission tag with the near field communication device; and storing the at least part of the sequence of program instructions in a program memory of the controller for processing by the controller.

The method of the present invention facilitates the programming of a programmable device without the need for keys to enter the programming instructions.

In an embodiment, the first transmission tag comprises a part of the sequence of program instructions, the method further comprising establishing a communication between the near field communication device and a further transmission tag comprising a further part of the sequence of program instructions; retrieving the further part of the sequence of program instructions from the further transmission tag with the near field communication device; and storing the further part of the sequence of program instructions in the program memory of the controller for processing by the controller. This has the advantage that the device may be programmed in a stepwise manner by individual instruction carrying transmission tags, which for instance is beneficial for educational purposes in case the programmable device is a programmable toy.

### BRIEF DESCRIPTION OF THE EMBODIMENTS

Embodiments of the invention are described in more detail and by way of non-limiting examples with reference to the accompanying drawings, wherein:

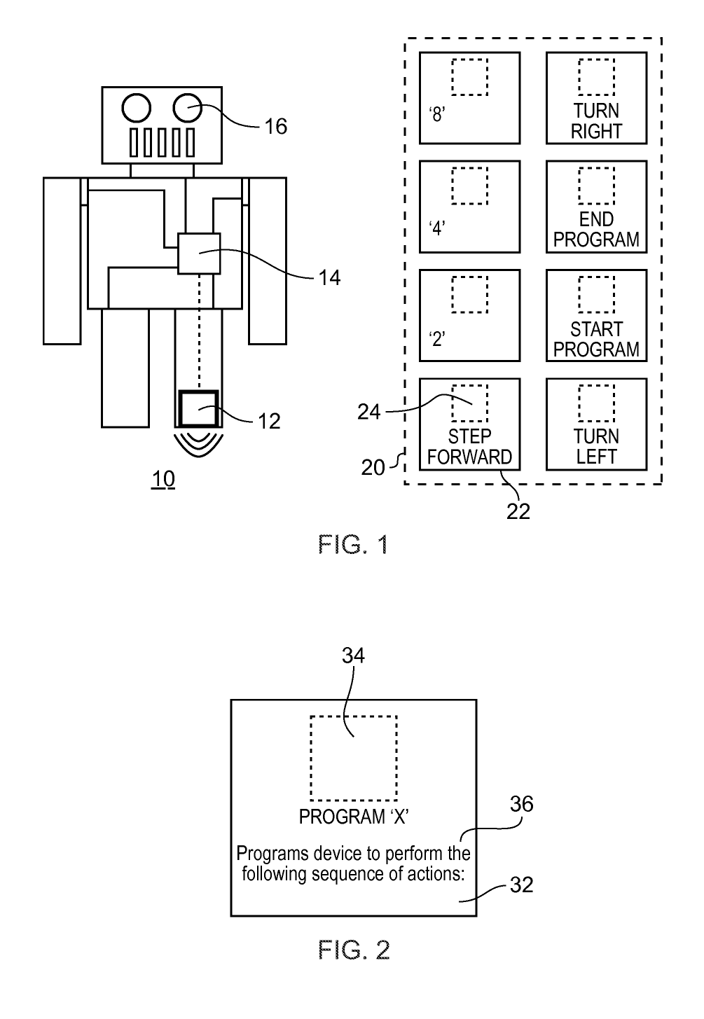

FIG. 1 schematically depicts a programmable system in accordance with an embodiment of the present invention;

FIG. 2 schematically depicts a programmable transmission tag for use in a programmable system of the present invention;

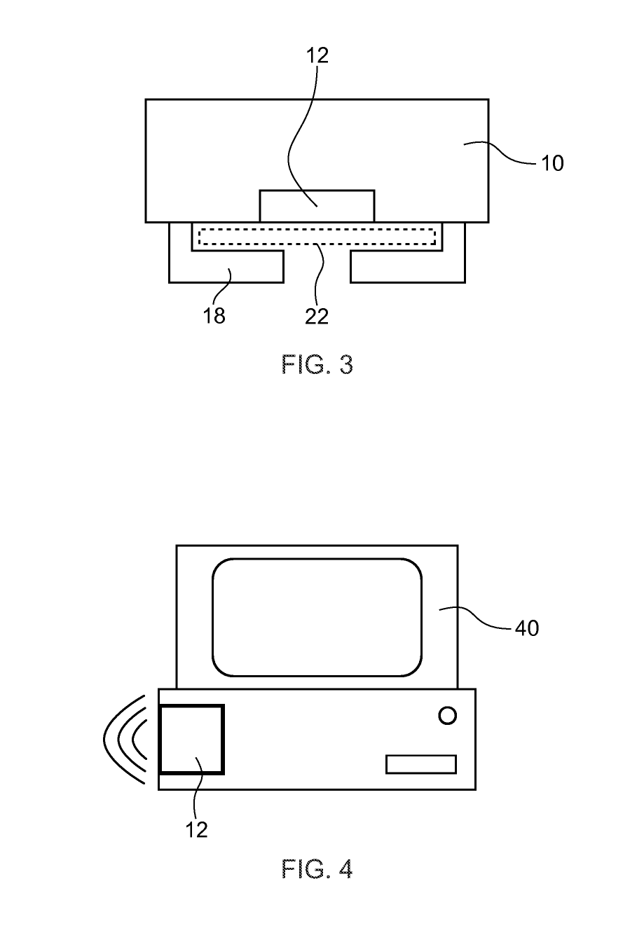

FIG. 3 schematically depicts an aspect of a programmable device in accordance with an embodiment of the present invention in greater detail; and

FIG. 4 schematically depicts a programmable device in accordance with another embodiment of the present invention.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

FIG. 1 shows a programmable system including a programmable device 10 and a set 20 of transmission tags 24, each of which are integrated in a respective carrier 22. In FIG. 1, the programmable device 10 is a toy robot, comprising a near field communication (NFC) device 12 coupled to a controller 14 arranged to control the movements of the various body parts of the toy robot, e.g. legs and arms, by executing a sequence of program instructions. In the context of the present invention, a sequence of program instructions comprises at least one instruction. The set 20 of transmission tags 24 comprises at least one transmission tag 24 comprising at least one instruction for programming the controller 14 of the toy robot by communicating the at least one instruction to the NFC device 10.

NFC is a standardized, short-range, wireless connectivity technology based on Radio Frequency Identification (RFID) technology, which uses magnetic field induction by a transmitted radio signal to enable communication between a reading device and a transmission device when these devices are brought in close proximity of each other. NFC operates in the unlicensed 13.56 MHz frequency band and supports data transfer rates of up to 424 kbit/s.

The transmission tag 24 is essentially an integrated circuit containing data, connected to an antenna. The data stored in the tag can be read and written by the NFC device 12, which may be a read-only device or may also be capable of writing data to a transmission tag such as the transmission tag 34 in FIG. 2. Upon returning to FIG. 1, NFC typically facilitates two modes of operation; passive operation, in which only the NFC device 12 generates an RF signal, while the transmission tag 24 uses load modulation to transfer data, powering itself from the RF signal received from the NFC device 12, and active operation between two NFC devices 12, which can encompass peer-to-peer operation, where both devices are capable of both read and write operations and both are able to generate an RF signal when initiating communication with the other device.”

The NFC device 12 may be any suitable NFC device, and the carriers 22 may be provided in any suitable form. For instance, the carriers 22 in the set 20 may all have the same shape and being distinguishable by means of different surface markings, e.g. images, pictograms, text and so on, or may have different shapes with each shape corresponding to a type of instruction. It will be understood that many more examples will be apparent to the skilled person. The carriers 22 may be made of any suitable material, e.g. paper, laminated paper, plastic, wood and so on. A transmission tag 24 may be integrated in a carrier 22 in any suitable way, e.g. by gluing or capturing in between two layers of a laminated structure. In an embodiment, the carrier 22 is a laminated printed card carrying a printed image and/or text referring to the instruction, with the transmission tag encapsulated in between two layers of the laminated carrier 22.

In an embodiment, at least some of the transmission tags 24 in the set 20 comprise instruction sequences, programmed to provide the programmable device 10 with a multi-instruction sequence. This is for instance useful when the programmable device 10 is a computer or a programmable machine in a factory, where it is important that programming errors are avoided. To this end, a complete multiple-instruction sequence may be provided on a single transmission tag 24.

In an alternative embodiment, the transmission tags 24 in the set 20 comprise single instructions, such that a multiple-instruction sequence may be compiled using different carriers 22. This is for instance useful when the programmable device is a toy robot, where a high programming flexibility is required and programming errors are unlikely to have a serious detrimental effect. At least some of the single instructions may be parameterized, e.g. “Turn Left 50 degrees” or “Move Forward 5 steps”, with the instruction and parameter value being identified on or by the carrier 22. Alternatively, an instruction requiring such a parameter value and the parameter value itself may be comprised in different transmission tags, such as shown in set 20 in FIG. 1, where the ‘STEP FORWARD’ instruction may be parameterized by any of the parameter values “2”, “4” and “8”. In case of a parameter being omitted from a programming sequence, the controller 14 may be configured to assume a default value, e.g.:

| | |
|---|---|
| IF | next data content = “new value” |
| THEN | instruction parameter := “new value” |
| ELSE | instruction parameter := “default value” |

This is a basic parsing operation well-known to the skilled person, and will not be further explained for reasons of brevity only. By assuming a default value for the parameter in the absence of a parameter being offered to the NFC device 12, a greater flexibility and tolerance in the programming process is achieved. A default value may also be assumed if no parameter value is offered to the NFC device 12 within a predefined time period, e.g. 30 or 60 seconds.

In an embodiment, the controller 14 comprises a parser for parsing the transmission tag instructions and converting them to machine code that can be executed by the controller 14. The machine code may be stored in the program memory (not shown) of the controller 14.

The programming mode of the programmable device 10 may be entered by a communication between the NFC device 12 and any instruction-bearing transmission tag 24, and may be terminated when no further transmission tag 24 is offered to the NFC device 12 within a predefined time period. Preferably, the set 20 comprises a carrier 22 comprising a transmission tag 24 for entering the programming mode of the programmable device 10, “START PROGRAM” in set 20 in FIG. 1 and a carrier 22 comprising a transmission tag 24 for exiting the programming mode of the programmable device 10, “END PROGRAM” in set 20 in FIG. 1. The start of a programming sequence typically triggers the controller 14 to erase its program memory (not shown) and to store the instruction sequence to be received in the program memory instead.

In addition to the control transmission tags 24 for entering and exiting the program mode of the programmable device 10, the set 20 may further comprise control transmission tags for initiating the execution of the programmed instruction sequence, for termination of the execution of the programmed instruction sequence, for executing a partial instruction sequence, i.e. testing a so far programmed sequence in programming mode, for ignoring a previous instruction and so on. In an alternative embodiment, such control instructions are entered in any other suitable way, e.g. by means of control switches on the programmable device 10 or by way, a wireless remote control and so on.

In an embodiment, the programmable device 10 is further responsive to a control instruction for storing the current sequence of program instructions residing in the program memory of the controller 14 in a transmission tag such as the transmission tag 34 in the carrier 32 shown in FIG. 2. The NFC device 12 may be configured to write this sequence into the transmission tag 34, after which the user may provide the carrier 32 with a label 36 for identification purposes. Alternatively, the programmable device 10 may comprise a further NFC device (not shown) for performing the write operation in addition to the NFC device 12.

In this manner, complex instruction sequences may be stored for future use. The programmable device 10 may be configured to divide a complex instruction sequence over a number of transmission tags 34 in case the sequence is too large to fit in the memory of a single transmission tag 34. In case of writing data to multiple transmission tags 34, each transmission tag 34 may also receive an identification code, e.g. a volume number, to ensure that the tags 34 may be read back into the programmable device 10 in the correct order.

The transfer of data to one or more transmission tags 34 may be initiated after a predefined delay following the reception of the write instruction, e.g. 2 or 5 seconds, to allow a programmer to bring the transmission tag 34 in the vicinity of the NFC device for writing the data into the transmission tag 34.

In a preferred embodiment, all the transmission tags 24 in the set 20 are read-only tags to prevent the programmable device 10 from overwriting pre-programmed transmission tags. This may be achieved in any suitable way, e.g. by the inclusion of a dedicated data pattern in the transmission tags. Such a data pattern may be used as a verification code that the programmable device 10 would first look for prior to initiating a write action, such that the write action into the transmission tag 24 would only be initiated if the verification code could not be found.

In an embodiment, the programmable device 10 comprises an output device 16 for notifying the programmer that an instruction has been successfully received and/or that an error has occurred. The output device 16 may be any suitable output device, e.g. a speaker for producing an audible signal or a blinking light, which may be mounted in the eye socket of a robot toy, on its head and so on. The output device may provide different signals for a successful and an erroneous instruction download, e.g. different audio signals, or different light signals, such as light blinking at a different frequency or a different number of times to allow a programmer to distinguish between a successful and a suspected erroneous instruction being provided to the controller 14.

A suspected erroneous instruction may be diagnosed by the controller 14 if the received instruction has not been recognized or when the same instruction has been received twice in a row too quickly, thus indicating an unintentional double read of an instruction, in which case the programmer may for instance instruct the controller 14 to ignore the last instruction, e.g. by using the appropriate transmission tag 24. Similarly, a ‘negative’ signal may be produced if the programmer offers another instruction-comprising transmission tag 24 to the programmable device after exiting the programming mode.

The output device 16 may also be used for other purposes, e.g. when storing an instruction sequence in a storage transmission tag 34. For instance, if the instruction sequence is too large to fit in the memory of the transmission tag 34 and the programmable device 10 does not support dividing the instruction sequence over multiple transmission tags 34, the output device 16 may produce a signal indicating that the instruction sequence is too large. Similarly, if the programmer has previously stored an instruction sequence on multiple transmission tags 34 and tries to reload the instruction sequence into the programmable device 10, the output device 16 may produce a signal when the order in which the transmission tags 34 are being presented is different to the order in which the transmission tags 34 were written to. The output device 16 may also generate a signal during writing an instruction sequence to multiple transmission tags 34 when a transmission tag 34 is full. Other examples will be apparent to the skilled person.

The use of multiple carriers 22 each comprising a transmission tag 24 carrying a single (or a few) instruction(s) has the advantage that the instruction sequence can be visualized by placing the carriers in the intended order, optionally preceded by a “START PROGRAM” and succeeded by an “END PROGRAM” instruction carrier 22, as previously explained. This makes the present invention particularly suitable for educational purposes.

Upon programming the programmable device 10, the execution of the programmed instruction sequence may be initiated by a dedicated control instruction, which may be provided in the form of a transmission tag 24. The programmable device 10 may terminate the execution of the programmed instruction sequence upon reaching the end of the sequence, or upon receiving a further dedicated ‘end execution’ instruction, which may also be provided in the form of a transmission tag 24.

In an alternative embodiment, the programming and execution modes of the programmable device 10 may be interleaved. For instance, the programmable device 10 may be arranged to execute an instruction as soon is it is received by the controller 14 from the NFC device 12. This for instance useful when the programmable device 10 is a toy robot, because it allows the programmer, e.g. the child playing with the programmable device 10 to lay out a purposive route of carriers 22 such that the toy robot moves from a previous carrier 22 to the next carrier 22 when executing the instruction retrieved from the transmission tag 24 in the previous carrier 22. This can help increase spatial awareness of the child playing with the toy robot, because the child needs to develop an understanding of the location the robot will reach at the end of the executed instruction such that a new instruction may be provided in this location. In case no new instruction is encountered, the toy may continue executing the previous instruction by repeating its execution or simply stop.

The scattering of carriers 22 on a game arena surface over which a toy robot may move can also be used as a multi-player game, wherein each player receives his own robot, which is subsequently placed on one of the carriers 22 in the game arena. The winner will be the player whose robot manages to keep moving the longest without getting stuck in a loop. Other game variants are of course also feasible.

It will be understood that the programmable device 10, or more accurately, the NFC device 12, should be placed in a well-defined orientation in respect of a transmission tag 24 in order to establish a communication therewith. For instance, in the case of the programmable device 10 comprising a programmable toy such as shown in FIG. 1, where the NFC device 12 is hidden in one of the legs of the toy, the toy should be placed on the carrier to bring the NFC device 12 is close enough vicinity to the transmission tag 24 to establish a communication therewith, e.g. the tag 24 should be placed within range of the radio signal generated by the NFC device 12. However, it will be appreciated that many other arrangements are equally feasible; FIG. 3 for instance is a top view of another programmable device 10, a toy robot, in accordance with the present invention, in which the NFC device 12 is embedded in the torso of the toy robot, with the toy robot further comprising a holder 18 for receiving a carrier 22. Other arrangements will be readily available to the skilled person.

In an embodiment, the programmable toy may form part of a virtual world existing on a computer or computer network. The instruction sequence programmed into the one or more transmission tags 34 may be transferred to the virtual representation of the programmable toy in the virtual world by providing a computer with a NFC device and downloading the instruction sequence into the virtual world using this computer.

In an embodiment of the programmable device 10 being a programmable toy, which in the context of the present invention is also referred to as a toy robot, the programmable toy may further comprise one or more motion sensors for detecting the motion of other programmable toys. This may be useful if the programmable toy may be used in a multi-toy combat environment such that the input from the motion sensors may influence the movements of the programmable toy, e.g. override the instructions programmed into the toy by means of the transmission tags 24. In addition to the movement instructions, the set 20 may also comprise combat instructions for the programmable toy, which are typically programmed into one or more transmission tags 24. Hence, the combat behavior of the programmable toy, e.g. “CHARGE”, “ATTACK”, “DEFEND” instructions, may also be programmable. The programmable toys may face combat in a combat arena equipped with NFC sensors, which each toy being assigned its own sensor, e.g. in one of the corners of the arena. The combat instructions may be temporarily stored in the NFC sensor and transferred to the toy when it returns to its sensor.

The NFC sensor in the arena may also be used to collect data from the toy gathered during combat, e.g. to facilitate playback of the combat in a virtual world or to facilitate an evaluation of the combat behavior of the opponent(s). Peer-to-peer communication between combat toys may be used to transfer virtual assets such as trophies, winner's belts and so on.

Although the present invention has been predominantly described in the context of programmable toys such as robots, it is once more emphasized that the present invention is not limited to such application domains. FIG. 4 shows an example of a different application of the present invention; a personal computer 40 is equipped with a NFC device 12 for checking upon start-up if a non-default start-up routine has to be followed by checking if a transmission tag 24 storing the non-default start up routine may be detected by the NFC device 12.

The following non-exhaustive list of application examples may also be considered:

A programmable device requiring a set of configuration parameters for its operation may be configured by providing it with a NFC device 12 and a transmission tag 24 comprising a configuration instruction comprising the required configuration parameters. Different sets of parameters may be used to bring the device in different configurations.

The sensitivity or performance of a toy remote controlled car could be changed if the toy was equipped with an NFC device 12 and the parameter settings were stored on a transmission tag 24. A number of tags, each containing different settings, could be provided to enable the car to emulate different real-life cars in the model world.

The character profile of a robotic toy could be modified. For example, cards would be provided for different personality types: happy, moody, aggressive, shy, and so on.

The attributes of the robotic toy, e.g. its speed, strength, health, weapons, etc, could be changed via NFC accessory cards or add-ons. For example, a robotic Wizard toy might be sold with an NFC accessory pack containing one spell, one weapon, one agility, etc. These can be used during interaction (combat or otherwise) with other robotic toys. If the interaction (e.g. battle) is successful then these items are boosted as well, e.g. the weapon is able to inflict more damage the next time it is used. Thus the data on the card is updated as a result of game play. Such NFC accessory cards can then be traded with friends or the toy itself.

An industrial machine could be re-programmed to carry out a particular set of tasks. The change would be instigated by presenting one or more NFC tags 24 to a NFC device 12, with the NFC device 12 either being embedded in the machine or external to the machine, and connected via a wired or wireless link. There would be no need for a keyboard and/or terminal in what may be a hostile environment due to dust, dampness, bright lights, and so on.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A programmable device comprising:
a controller for executing a sequence of program instructions to control the programmable device; and
a near field communication device for retrieving the program instructions from at least one transmission tag and for providing the controller with the retrieved sequence of program instructions.

2. The programmable device of claim 1, wherein the controller is arranged to receive an individual instruction from a first transmission tag.

3. The programmable device of claim 2, wherein the controller is further arranged to receive a parameter for the individual instruction from a second transmission tag.

4. The programmable device of claim 1, wherein the controller is arranged to be brought into a programming mode by a program initiation transmission tag and is further arranged to exit the programming mode by a program termination transmission tag.

5. The programmable device of claim 1, further comprising a further near field communication device arranged to write the sequence of program instructions to a further transmission tag in response to a sequence write instruction.

6. The programmable device of claim 1, wherein the near field communication device for retrieving the program instructions from at least one transmission tag and for providing the controller with the retrieved sequence of program instructions is further arranged to write the sequence of program instructions to a further transmission tag in response to a sequence write instruction.

7. The programmable device of claim 5, wherein the near field communication device for retrieving the program instructions from at least one transmission tag is arranged to receive the sequence write instruction from a transmission tag.

8. The programmable device of claim 2, wherein the controller is arranged to execute the individual instruction before receiving a next instruction.

9. The programmable device of claim 1, further comprising an alarm for notifying an error in the sequence of program instructions.

10. The programmable device of any of claim 1, wherein the controller is responsive to a dedicated instruction for executing of the sequence of program instructions, and wherein the set of transmission tags comprises a transmission tag comprising the dedicated instruction.

11. A set (20) of transmission tags for programming the programmable device of any of claim 1, at least some of the transmission tags in said set comprising at least one program instruction for said programmable device.

12. The set of transmission tags of claim 11, wherein at least some of the program instructions require an instruction parameter, the set of transmission tags further comprising at least some transmission tags comprising respective parameter values for said program instructions.

13. The set of transmission tags of claim 10, further comprising:
a transmission tag for initiating a programming sequence of the programmable device; and
a transmission tag for terminating a programming sequence of the programmable device.

14. The set of transmission tags of any of claim 11, further comprising a transmission tag for, whilst in programming mode, triggering the programmable device to execute an intermediate sequence of program instructions transferred to the programmable device.

15. A programmable system comprising a programmable device comprising a controller for executing a sequence of program instructions to control the programmable device; and
a near field communication device for retrieving the program instructions from at least one transmission tag and for providing the controller with the retrieved sequence of program instructions and the set of transmission tags of claim 11.

16. A method of programming a programmable device comprising a controller for executing a sequence of program instructions to control the programmable device and a near field communication device coupled to the controller, the method comprising:
establishing a communication between the near field communication device and a first transmission tag comprising at least a part of the sequence of program instructions;
retrieving the at least part of the sequence of program instructions from the first transmission tag with the near field communication device; and
storing the at least part of the sequence of program instructions in a program memory of the controller for execution by the controller.

17. The method of claim 16, wherein the first transmission tag comprises a part of the sequence of program instructions, the method further comprising:
establishing a communication between the near field communication device and a further transmission tag comprising a further part of the sequence of program instructions;
retrieving the further part of the sequence of program instructions from the further transmission tag with the near field communication device; and
storing the further part of the sequence of program instructions in the program memory of the controller for execution by the controller.
